(19) United States
(12) Patent Application Publication
(10) Pub. No.: US 2015/0313272 A1
(43) Pub. Date: Nov. 5, 2015

(54) METHOD AND APPARATUS FOR ASEPTICALLY DOSING AND PREPARING FOOD MATERIALS

(71) Applicants: Yingchang Han, Dublin, OH (US); Ernst Beutler, Langnau (CH)

(72) Inventors: Yingchang Han, Dublin, OH (US); Ernst Beutler, Langnau (CH)

(21) Appl. No.: 14/413,348

(22) PCT Filed: Jul. 12, 2012
(86) PCT No.: PCT/US2012/046456

§ 371 Date: Apr. 10, 2015

(51) Int. Cl. A23L 3/00; B67C 3/20; A23L 2/02; B65B 3/04; B65B 55/14; A23L 2/42

(52) U.S. Cl. CPC A23L 3/00; B65B 55/14; A23L 2/42; A23L 2/02; B65B 3/04; B67C 3/204; A23V 2002/00

(57) ABSTRACT

Method and apparatus of producing sterile liquid food products are provided. The method comprising the steps of: aseptically sterilizing heat sensitive food materials using a sterile filter; filling an aseptic container having a plastic member with the sterilized heat sensitive materials; heat sterilizing non-heat sensitive food materials using a sterilization process in a production line; connecting the filled aseptic container to the product line using a heat sealer that creates a sterile connection between the plastic member of the aseptic container and a fluid flow path into the production line; feeding the sterilized heat sensitive food materials through a dosing valve and mixing the sterilized heat sensitive food material with the non-heat sensitive food materials that have been sterilized; and filling a second container with the mixture.

### BACKGROUND

The present invention relates generally to methods and apparatus for preparing food materials. More specifically, the present invention relates to methods and apparatus for preparing food materials, especially beverages that require aseptic components.

In preparing liquid food materials, especially beverages, concentrates, soups, creamers, nutritional products, culinary products, etc., it is known to provide aseptic components. One method of preparing such food products is to mix of all the components together and then subject the components to a heat treatment step to sterilize the composition. The problem with this approach is that some of the heat sensitive components, for example, flavor, are degraded during the heating step. Additionally, if direct-heating via steam injection, is used, the subsequent flashing step causes substantial loss of volatile flavor/aromas.

It is known to aseptically dose liquid food materials into the other beverage components that are sterilized using thermal treatment. By aseptically dosing the liquid materials, one can save the loss of the heat sensitive components by not subjecting them to heat treatment. This can improve the sensory profile of the product. There are a variety of heat sensitive food materials that are used in, for example, beverages including flavors, colors, vitamins, enzymes, juices, fermentation cultures, probiotics, aroma, mono- and poly-unsaturated fatty acids, polyphenols, bacterias, medications, and anti-oxidants.

In the prior art, it has been known to aseptically dose using in-line filtration as part of the production line. An example of using in-line filtration as part of the production line is the Tetra Aldose system, practiced by Tetra Pak. An issue with sterilizing in-line as part of the production line is that if the filter breaks, the entire batch of product is lost. Furthermore, if it is desired to run a different component, for example, flavor, the production line must be shut down and cleaned. Likewise, when it is necessary to change filters, this requires the system to be shut down and cleaned.

It is also known to aseptically dose using a needle injection system. An example of a needle injection system is Tetra Flexdose, practiced by Tetra Pak.

### SUMMARY

The present invention provides methods and apparatus for aseptic dosing of liquid food materials. The method and apparatus is highly flexible and is multifunctional. It can be applied at different locations in a processing line and provides a number of advantages over prior apparatus and methods.

The present disclosure provides, in an embodiment, a method of producing food products comprising the steps of: aseptically sterilizing heat sensitive food materials using a sterile filter; filling an aseptic container having a tube with the sterilized heat sensitive materials; connecting the filled aseptic container to a production line using a heat sealer that creates a sterile connection between the tube of the aseptic container and a fluid flow path into the production line; heat sterilizing non-heat sensitive food materials using a thermal sterilization process in the production line; feeding the sterilized heat sensitive food materials through a dosing valve and mixing the sterilized heat sensitive food materials with the non-heat sensitive food materials that have been sterilized; and filling a second container with the mixture. The heat sensitive food ingredients and non-heat sensitive food ingredients can be mixed in the dosing valve.

In an embodiment, the heat sensitive food material is selected from the group consisting of flavors, colors, vitamins, enzymes, juices, fermentation cultures, probiotics, aroma, mono- and poly-unsaturated fatty acids, polyphenols, bacterias, medications, and anti-oxidants.

In an embodiment, the method comprises the step of detaching one aseptic container from the production line and sterilely connecting to the production line a different container containing a different aseptically sterilized heat sensitive food ingredient. The different container can be selected from an inventory of containers containing various aseptically sterilized heat sensitive ingredients.

The sterile connection can be made by welding the tube to a second tube or hose that defines a flow path. In addition, the method can include the step of sterily disconnecting the container from the production line and storing the container for later use.

In a further embodiment, the present disclosure provides a method of aseptically dosing a liquid material into a beverage or concentrate comprising the steps of: heat sterilizing a first food material using a thermal sterilization process in a production line; aseptically sterilizing a second food material using a sterile filter in a process that is not performed as part of the production line; filling an aseptic bag having a tube with the sterilized second food material; connecting the filled aseptic bag to a fluid path that is in fluid communication with a dosing valve using a heat sealer that creates a sterile connection between the tube of the aseptic bag and the flow path into a dosing valve; feeding the sterilized second food material through the dosing valve; mixing the sterilized first food material with the sterilized second food material; and filling a container with the sterilized mixture of the first and second food material.

In a further embodiment, the present disclosure provides an apparatus for preparing beverages comprising: a production line including a plastic member that can be sterily connected to a plastic tube of an aseptically filled bag, the plastic member being located upstream of a dosing valve. A material feed path is provided that is designed to allow heat sterilized food material to sterily flow therethrough. And the dosing valve is designed to inject material that flows through the plastic member into the heat sterilized material.

An advantage of the present invention is it provides an improved method of aseptically dosing liquid food materials.

Another advantage of the present invention is it provides an improved apparatus for preparing food beverages that include aseptic components.

Moreover, an advantage of the present invention is it provides a method and apparatus having high flexibility and multiple functions for preparing food beverages including aseptic components.

A still further advantage of the present invention is that it provides for the accurate dosing of small amounts of aseptic material.

Furthermore, an advantage of the present invention is that it saves heat sensitive materials and provides better quality product.

An additional advantage of the present invention is it provides a method and apparatus that provides safe, consistent aseptic operation and is easily cleanable.

Another advantage of the present invention is that it can be used with unsterile ingredients or sterile ingredients, as the bag dosing method starts with sterile ingredients and the filtration method converts unsterile ingredients into sterile ingredients

Additional features and advantages are described herein, and will be apparent from the following Detailed Description and the figures.

### BRIEF DESCRIPTION OF THE FIGURES

FIG. 1 is a process sequencing diagram illustrating an embodiment of the processes of the present disclosure.

FIG. 2 illustrates, schematically, an embodiment of the process for sterilizing the heat sensitive components of the present disclosure.

FIG. 3 illustrates, schematically, an embodiment of the process for making products.

FIG. 4 illustrates an embodiment of a container pursuant to an embodiment of the present disclosure.

### DETAILED DESCRIPTION

The present disclosure provides apparatus and methods for preparing food materials including aseptic components. As used herein the term “food material(s)” include beverages such as, for example, juices. Pursuant to an embodiment of the present disclosure, aseptic dosing is used to prevent the loss of heat sensitive components. Heat sensitive food materials which can be used pursuant to an embodiment of the present invention include, inter alia, flavors, colors, vitamins, enzymes, juices, fermentation cultures, probiotics, aroma, mono- and poly-unsaturated fatty acids, polyphenols, bacterias, medications, and anti-oxidants. To this end, heat sensitive components are aseptically dosed into other liquid food materials after thermal treatment of those materials. Typically, the heat treated materials are the less heat sensitive components so that they can be heated, in order to sterilize same, without a loss of materials or degradation of the sensory profile of the materials.

Pursuant to the present disclosure, methods and apparatus are provided that afford greater flexibility and multifunctional systems. Accurate aseptic dosing can be provided even at small dosing levels. The aseptic operations are safe and consistent and, due to the design of the apparatus, the device is easily cleaned. The resultant product has better sensory profile resulting in a higher quality finished product.

In an embodiment, generally, the process of the present invention is as follows. Heat sensitive food materials are sterilized using a sterile filter offline. After the heat sensitive materials are sterilized, they are filled into aseptic containers such as bags which are sealed. These bags can then be stored until later used. In order to create a resultant product, the aseptic bags are then coupled to a production line for creating a final beverage product. Specifically, the bags are coupled upstream of a dosing valve using an aseptic sealing technique described below. The material in the bag can then be dosed into the other components of the food product, e.g., the heat non-sensitive components, and then filled into containers.

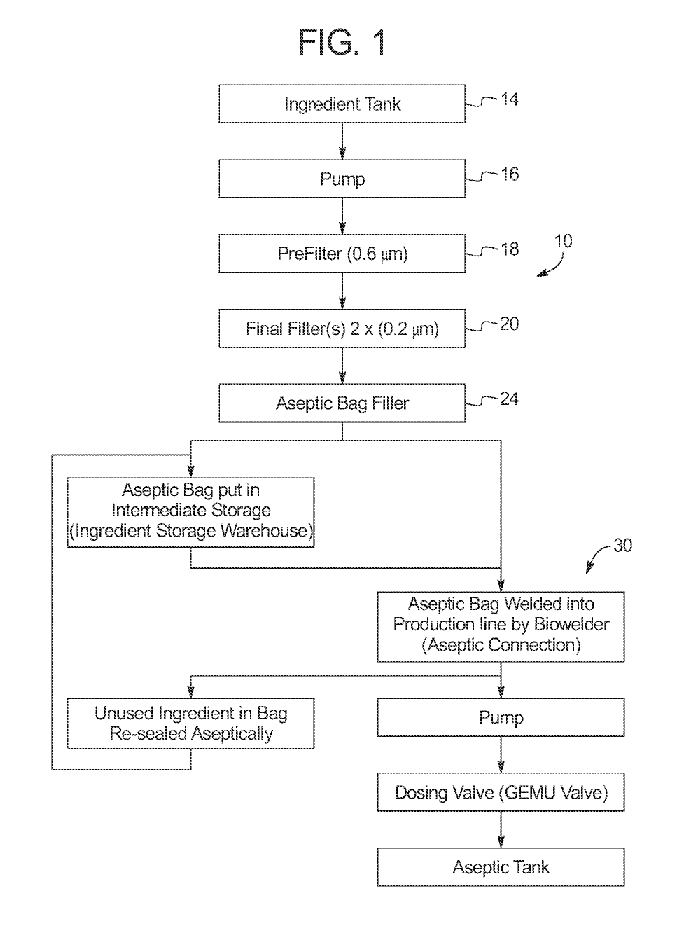

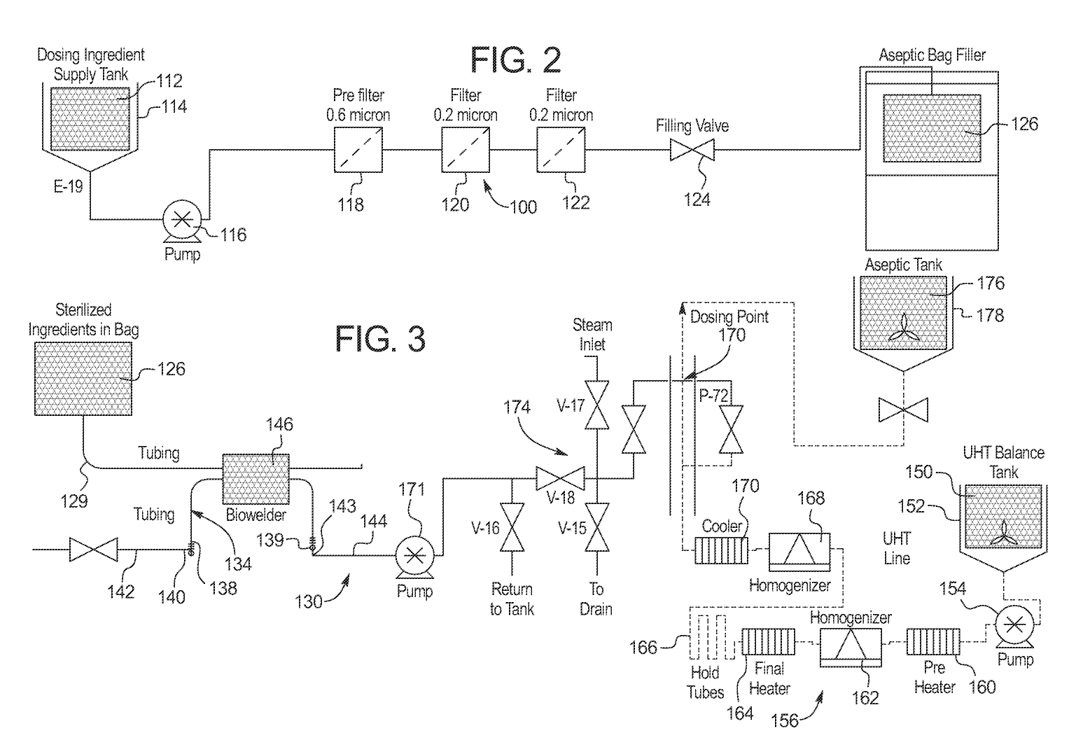

Referring now to FIGS. 1-3, the process for producing products pursuant to an embodiment of the disclosure is set forth. As illustrated in the figures, for example, FIG. 1, heat sensitive material is sterilized off line in a process 10 separate and apart from the process 30 for making the final product. In the illustrated embodiment, the ingredients are sterilized using a filtration system. FIG. 2 illustrates, schematically, the process 100 for sterilizing heat sensitive materials. For the sake of brevity and convenience, hereinafter both FIGS. 1 and 2 will be referred together at times.

Referring to FIGS. 1 and 2, prior to running any ingredients through the filtration system 10 and 100, the system is heated, sterilized, and then cooled. In order to maintain aseptic conditions within the system 10 and 100, steam barriers and positive pressure are used in the lines. Once sterilization of the system 10 and 100 has been completed, ingredients 112 are filled into an ingredient tank 14 and 114. As previously noted, these ingredients 112 are typically heat sensitive food materials, for example, flavors. For the sake of convenience, Applicants will refer to the specific heat sensitive ingredient as flavor, in the following description. However, it should be noted that this is by way of example and not limitation. Accordingly, anytime the word “flavor” is used, it should be understood that it can be any heat sensitive ingredient.

The flavor 112 to be sterilized is placed in the ingredient tank 14 and 114. The flavor is then pumped using a pump 16 and 116 through a prefilter 18 and 118. The purpose of the prefilter 18 and 118 is to remove larger contaminants. To this end, the prefilter 18 and 118 preferably has a pore size of 0.5 microns or greater, in an embodiment, the prefilter has a pore size of 0.6 microns. However, it should be noted that it is not necessary to use a prefilter 18 and 118 in the system 10 and 110. Pre-filters may extend the life of the sterile filter

From the prefilter 18 and 118, flavor is then pumped through sterile filters 20 and 120 and 122. A variety of sterile filters are known in the art. In order to aseptically sterilize the material, the filters have a pore size of 0.5 microns or less. The sterile filters 20 and 120 and 122 preferably has a pore size of 0.2 microns or less. Examples of such sterile filters include filters marketed by Pall and Millipore. A specific filter that can be used is the Ultipor N66. The sterile filters 20 and 120 and 122 will sterilize the flavor as it is filtered therethrough. In the illustrated embodiment, two sterile filters 120 and 122 are utilized. However, only one sterile filter is necessary. The second filter 122 acts as a backup in case the first filter 120 breaks.

Although an “in-line” filtration system 10 and 100 is provided, this filtration is offline from the production line for the final product. Accordingly, any problems during this filtration and sterilization process 10 and 100 will not adversely impact the production line 30 and 130. Therefore, if a line were to break or a filter leak, the production line 30 and 130 would not have to be shut down.

Once the flavors have been sterilized by being passed through the sterile filters 20 and 120, they then are dosed aseptically into a container 126. Any aseptic filling valve 24 and 124 can be utilized to fill the container 126. In an embodiment, a Raypak filling valve is used.

As noted above, in an embodiment, the flavors are dosed into a container 126. In an embodiment, the container 126 is a bag. Any bag 126 that can maintain the aseptic sterility of the flavor can be utilized to store the flavor.

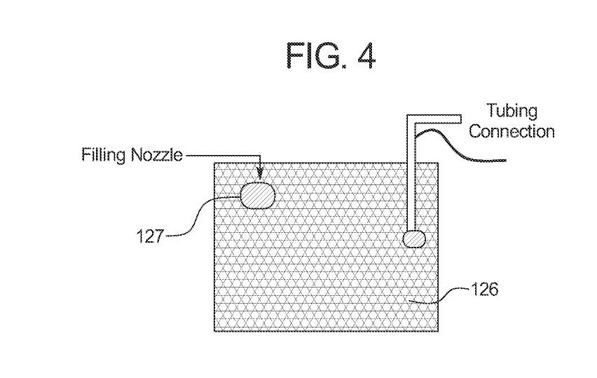

Referring to FIG. 4, an embodiment of the container 126, e.g., a bag is illustrated. The bag 126 includes a filling nozzle 127 that allows flavor to fill an interior of the container 126. Once the container 126 is filled, the filling nozzle is sealed. The container 126 includes a tube 129 extending therefrom so that it can be coupled to the production line 30 and 130 as described below. It should be noted that the exact structure and construction of the container 26 and 126 and filling nozzle 127 can vary. What is necessary is that the container maintains sterility and can be coupled to the production line 30 and 130 as set forth below.

After the containers 126 are filled, they are sealed and can either be immediately used in the production line 30 and 130 or stored under proper conditions. For example, the containers 126 can be stored at ambient conditions and still maintain sterility.

As will be seen hereinafter, one of the advantages of the present disclosure is that it provides versatility in that the flavors, or other heat sensitive ingredients, can be used or interchanged, when necessary, in the production line 30 and 130. Thus, the methods and apparatus of the present disclosure have great flexibility and allows for a variety of products to be made in the production line without substantial down time.

Referring to FIG. 3, when it is desired to use the flavor, the aseptic bag 126 is welded into the production line 130. To this end, the tube 129 on the bag 126 is welded to a corresponding plastic member 134 in the production line 130. In an embodiment, the tube 136 in the production line 130 is defined by a hose or tube that is flexible. The flexible hose or tube is secured at one end 138 to an outlet 140 of a line 142 and at a second end 139 an inlet 143 of line 144. To this end, preferably the hose is coupled to fittings on the production line using clamps or other arrangements. The flexible structure of the hose or tube 134 allows the interior of the hose 134 to be sterilized when the production line is sterilized.

The tube 129 of the container 126 is welded to the flexible tube 134 using a device 146 that can create a sterile connection between two plastic tubes. Any apparatus that can provide a sterile connection in an unsterile environment can be utilized. One device that provides sterile connection and disconnection in thermoplastic tubings is the Biowelder 30 available from Sartorius. The Biowelder is utilized in biopharmaceutical manufacturing processes in order to maintain sterility while making a connection. The Biowelder is a fully automated device for connecting thermoplastic tubing in a sterile welding operation. Any tubing can be utilized although preferably tubing having an outer diameter of ¼ to ¾ of an inch can be utilized.

By creating a sterile connection between the production line 130, and, specifically, the flexible hose 134 and the aseptic bag 126, greater flexibility in the production process is provided. As noted above, the production facility can have an inventory of aseptic bags 126 and switch between flavors with only a flavor rinse in the production line 130 instead of a full shutdown, clean and resterilization. Also, by using a sterile connection device 146, partially used bags 126 can be resealed and used later in the production process. Thus, great cost savings can be realized.

As noted above, FIG. 3 is a schematic of a production line for making food products, particularly beverages. As illustrated, non-heat sensitive material 150 is fed from a tank 152 through a pump 154 to a sterilization area 156. It should be noted that the term “non-heat sensitive materials” is being used broadly to include any materials that are traditionally heat sterilized, even if it degrades the product. The non-heat sensitive material 150 is heat sterilized using any heat sterilization method such as UHT, HTST, pasteurization, or any other thermal sterilization process. To this end, the material is processed until sterile. The thermally treated materials are then fed to a dosing point 172.

As noted above, the aseptic bag 126 is connected to the production line 130 so that the heat sensitive material, for example, flavors, can be dosed into the heat non-sensitive materials. To this end, they are fed through a pump to a dosing valve 174. In an embodiment, the dosing valve 174 is a CIP/SIP cleanable dosing unit. In a more specific embodiment, the dosing valve 174 is a Gemu valve dosing valve. These valves are available from Gemu Valves, Inc. in Germany. However, it should be noted that a variety of valves can be utilized as the dosing valve 174. For example, any cluster block dosing valve can be utilized as well as a double chamber dosing valve such as the Aseptomag aseptic double chamber dosing valve. What is required is that the valve 174 can allow a flow of the sterilized material therethrough and the ability to dose the flavor into a further product with preferably CIP (cleaning in place) and SIP (sterilization in place) functionality. The flavor and non-heat sensitive materials are then mixed at a dosing point 170 together and the resultant product 176 is then transferred into an aseptic tank 178.

As compared to prior dosing systems, the present disclosure provides a number of advantages. In a conventional system that involves adding the flavors prior to heat treatment and then subjecting the stream to thermal heating, subsequently and filling the heat sensitive flavor, components are degraded during the heating step. Additionally, if there is a direct heating and subsequent flashing step, there is a loss of volatile flavors and aromas. In contrast, in the present disclosure, heat sensitive flavors are fully preserved and further enhanced as the quality/flavor of the filled products.

In conventional systems that use an in-line filter in the production line, the flavor injection is inflexible and typically fit for large production lines with a single dosing component. This is due to the fact that the flavors are passed through the filter which removes the non-aseptic components. A base stream is subjected to thermal sterilization, cooled, and then the aseptic flavors are added prior to filling. Because the flavors are sterilized in-line in the production line, any flavor change requires cleaning the in-line filtering and injection system. Moreover, a filter change is required before cleaning of the system. Still further, if the filters leak during production, sterility can be lost and large volumes of filled product must be discarded.

In contrast, pursuant to the present disclosure, should a filter be blocked or break during the aseptic flavor filling operation, the filter flavor can be reprocessed (filter sterilized) thus avoiding the loss of large volumes of product. Flavor changes can be easily made without sterilizing the entire flavor injection system. Partially used flavor bags can subsequently be reused. Multiple flavors of product can be easily and quickly made and stored aseptically.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of producing food products comprising the steps of:
aseptically sterilizing heat sensitive food materials using a sterile filter;
filling an aseptic container having a tube with the sterilized heat sensitive materials;
connecting the filled aseptic container to a production line using a heat sealer that creates a sterile connection between the tube of the aseptic container and a fluid flow path into the production line;
sterilizing non-heat sensitive food materials using a thermal sterilizing step in the production line;
feeding the sterilized heat sensitive food materials through a dosing valve and mixing the sterilized heat sensitive food material with the non-heat sensitive food materials that have been sterilized; and
filling a second container with the mixture.

2. The method of claim 1, wherein the heat sensitive food material is selected from the group consisting of flavors, colors, vitamins, enzymes, juices, fermentation cultures, probiotics, aroma, mono- and poly-unsaturated fatty acids, polyphenols, bacterias, medications, and anti-oxidants.

3. The method of claim 1 comprising the step of detaching the aseptic container from the production line and sterily connecting to the production line a different container including a different aseptically sterilized heat sensitive food ingredient.

4. The method of claim 3, wherein the different container is selected from an inventory of containers.

5. The method of claim 1, wherein the heat sensitive food ingredients and non-heat sensitive food ingredients are mixed in the dosing valve.

6. The method of claim 1, wherein the sterile connection is made by joining the tube to a second tube that defines a flow path.

7. The method of claim 1 including the step of sterily disconnecting the container from the production line and storing the container for later use.

8. The method of claim 1, wherein the container is any packaging apparatus having the appropriate joining tube.

9. A method of aseptically dosing a liquid material into a beverage food product comprising the steps of:
sterilizing a first food material using a thermal sterilizing process in a production line;
aseptically sterilizing a second food material using a sterile filter in a process that is not performed as part of the production line;
filling an aseptic bag having a tube with the sterilized second food material;
connecting the filled aseptic bag to a fluid path that is in fluid communication with a dosing valve using a heat sealer that creates a sterile connection between the tube of the aseptic bag and the flow path into a dosing valve;
feeding the sterilized second food material through the dosing valve;
mixing the sterilized first food material with the sterilized second food material; and
filling a container with the mixture of the first and second food materials.

10. The method of claim 9, wherein the first food material is selected from the group consisting of flavors, colors, vitamins, enzymes, juices, fermentation cultures, probiotics, aroma, mono- and poly- unsaturated fatty acids, polyphenols, bacterias, medications, and anti-oxidants.

11. The method of claim 9 comprising the step of detaching the aseptic bag from the valve and sterily connecting a different bag including a different aseptically sterilized food ingredient.

12. The method of claim 9, wherein the first and second food materials are mixed in the dosing valve.

13. The method of claim 9, wherein the sterile connection is made by welding the tube to a second tube that defines a flow path.

14. The method of claim 9 including the step of sterily disconnecting the bag from the production line and storing the bag for later use.

15. An apparatus for preparing liquid food products comprising:
a production line including a plastic member that can be sterily connected to a plastic tube of a container, the plastic member being located upstream of a dosing valve;
a material feed path that is designed to allow food material that has been sterilized to flow through; and
the dosing valve being designed to inject sterile material that flows through the plastic member into the heat sterilized material.

16. The apparatus of claim 15, wherein the plastic member is a flexible tube.

17. The apparatus of claim 15 including a sterile welder that can weld a portion of the plastic member to a portion of the plastic tube.
